(19) United States
(12) Patent Application Publication
(10) Pub. No.: US 2006/0232444 A1
(43) Pub. Date: Oct. 19, 2006

(54) Mobile communication terminal and method for providing intelligent vehicle information

(75) Inventor: Ju-Hyoung Lee, Seoul (KR)

Correspondence Address: JONATHAN Y. KANG, ESQ.;LEE, HONG, DEGERMAN, KANG & SCHMADEKA, P.C., 14th Floor, 801 S. Figuerao Street, Los Angeles, CA, 90017-5554, US

(73) Assignee: LG Electronics Inc.

(21) Appl. No.: 11/403,791

(22) Filed: Apr. 12, 2006

(30) Foreign Application Priority Data
Apr. 13, 2005 (KR) 10-2005-0030843

(51) Int. Cl. G08G 1/123

(52) U.S. Cl. 340/995.19

(57) ABSTRACT

A mobile communication terminal and method for providing intelligent vehicle information are disclosed. The mobile communication terminal includes a situation recognizing system for detecting real-time situational and pre-set reference, and a data transmission/reception unit for transmitting the detected situational and the pre-set reference information to a vehicle internal system.

### CROSS REFERENCE TO RELATED APPLICATIONS

Pursuant to 35 U.S.C. § 119(a), this application claims the benefit of earlier filing date and right of priority to Korean Application No. 10-2005-0030843, filed Apr. 13, 2005, the contents of which are hereby incorporated by reference herein in their entirety.

### BACKGROUND OF THE INVENTION

1. Field of the Invention

The present invention relates to a mobile communication terminal and, more particularly to a mobile communication terminal and method for providing an intelligent vehicle information capable of controlling a vehicle internal system (i.e., an “automobile telematics” system) in real time.

1. Description of the Related Art

In general, an intelligent vehicle information system (i.e., telematics) refers to a highly technically integrated system that combines a vehicle internal system including various vehicle electronic devices and a communication network outside a vehicle through a CDMA (Code Division Multiple Access), a wireless LAN, and Internet communication.

The intelligent vehicle information system provides various information about conditions inside and outside the vehicle to the driver and the passenger. Demands for the intelligent vehicle information system are expected to increase in the future with growing demands for vehicles having convenience, comfort and luxury.

The related art of an intelligent vehicle information system will now be described with reference to FIG. 1.

FIG. 1 is a block diagram showing a related art intelligent vehicle information system including a mobile communication terminal 100 for checking whether a user is an authorized user based on information provided by a user, and transmitting data according to the result and having a first user recognizing unit 150 and a first data transmitting/receiving unit 120; and a vehicle internal system 200 for controlling the vehicle based on the received data and having a second data transmitting/receiving unit 240 and a vehicle internal controller 230.

The operational principle of the related art intelligent vehicle information system constructed as described above will now be explained.

First, the mobile communication terminal 100 checks whether a user is an authorized user based on information provided by the first user recognizing unit 150. Namely, the mobile communication terminal 100 checks whether the user is an authorized user having authority for controlling the vehicle internal system through a password, fingerprint recognition, voice recognition or an IC (Integrated Circuit) security card.

When the mobile communication terminal 100 transmits data indicating that the user is an authorized user to the vehicle internal system 200 through the first data transmitting/receiving unit 120, the vehicle internal system 200 sets a vehicle convenience system 210 with pre-set values according to the data received through the second data transmitting/receiving unit 240. For example, the vehicle internal system 200 can automatically control an interior cabin temperature, a power seat angle, a rear view mirror angle, and a side mirror angle as previously established by the user (user preference).

In addition, the vehicle internal system 200 can also determine whether a user is an authorized user through information provided by the second user recognizing unit 220 as well as information provided by the first user recognizing unit 150.

However, the related art intelligent vehicle information system suffers from a problem that the user is recognized through the mobile communication terminal and the vehicle internal system is controlled according to a value previously set by the user, so the vehicle internal system cannot be controlled in real time.

### SUMMARY OF THE INVENTION

Therefore, an object of the present invention is to provide a mobile communication terminal (“terminal”) and method for providing intelligent vehicle information capable of controlling a vehicle internal system in real time by detecting situational information regarding user surroundings and pre-set reference information, and transmitting the detected situational and pre-set reference information to the vehicle internal system.

To achieve at least the above objects in whole or in part, a mobile communication terminal is provided for providing intelligent vehicle information, comprising: a situation recognizing system for detecting situational information and pre-set reference information corresponding to the situational information; and a data transmission/reception unit for transmitting the detected situational and the pre-set reference information to a vehicle internal system.

To achieve at least these advantages in whole or in part, there is further provided a method for providing intelligent vehicle information of a terminal, comprising: detecting situational information inside a vehicle and pre-set reference information corresponding to the situational information; and transmitting the detected situational and pre-set reference information to a vehicle internal system.

To achieve at least these advantages in whole or in part, there is further provided an intelligent vehicle information system comprising: a terminal for detecting situational and pre-set reference information regarding user surroundings, and transmitting the detected situational and pre-set reference information and a vehicle internal system receiving the transmitted situational and pre-set reference information, and being controlled in real time based on the received situational information and pre-set reference information.

To achieve at least these advantages in whole or in part, there is further provided a method for controlling an intelligent vehicle information system comprising: a terminal detecting situational and pre-set reference information regarding user surroundings by the terminal transmitting the detected situational and pre-set information to a vehicle internal system; and vehicle internal system outputting a control signal based on the received situational information and pre-set reference information.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic block diagram showing a related art intelligent vehicle information system;

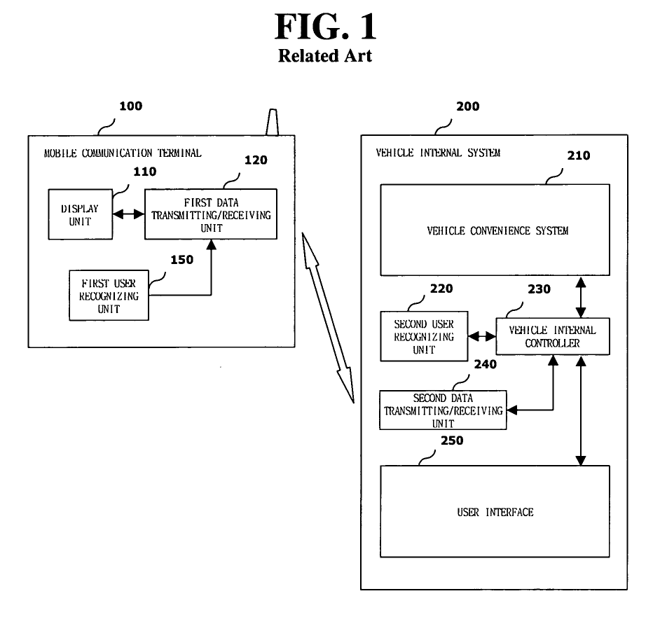

FIG. 2 is a schematic block diagram showing an intelligent vehicle information system in accordance with one embodiment of the present invention;

FIG. 3 is a flow chart illustrating a method for controlling the intelligent vehicle information system in accordance with one embodiment of the present invention; and

FIG. 4 is a schematic block diagram showing an intelligent vehicle information system in accordance with another embodiment of the present invention.

### DETAILED DESCRIPTION OF THE INVENTION

A terminal for providing intelligent vehicle information capable of controlling a vehicle internal system in real time by detecting situational and pre-set reference information regarding user surroundings and transmitting the detected situational information and pre-set information to the vehicle internal system, and its enhancement method, in accordance with the present invention will now be described with reference to the accompanying drawings.

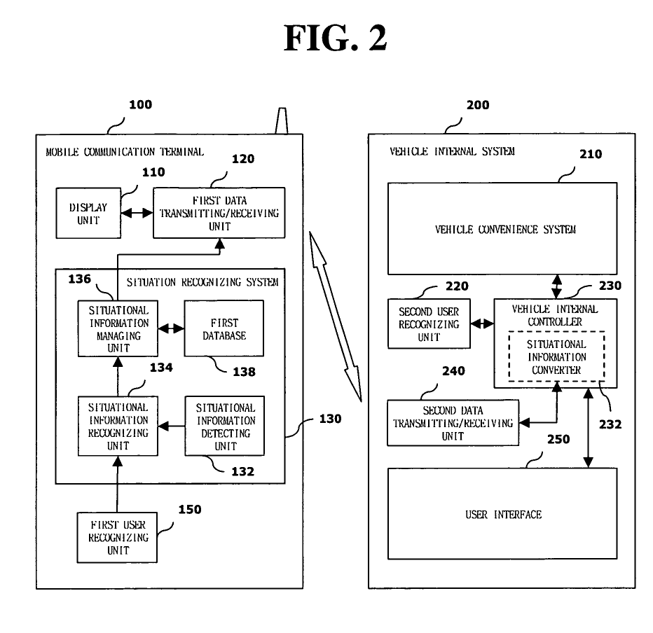

FIG. 2 is a schematic block diagram showing an intelligent vehicle information system in accordance with one embodiment of the present invention.

As shown in FIG. 2, the enhanced intelligent vehicle information system in accordance with a one embodiment of the present invention includes a terminal 100 for detecting and transmitting situational and pre-set reference information and wherein the terminal comprises a situation recognizing system 130 and a first data transmitting/receiving unit 120; and a vehicle internal system 200 controlled in real time based on the received situational information and reference information, wherein the vehicle internal system 200 comprises a second data transmitting/receiving unit 240, a situational information converter 232, a vehicle internal controller 230 and a vehicle convenience system 210.

The situation recognizing system 130 includes a situational information detecting unit 132 for detecting situational information, a situational information recognizing unit 134 for receiving the detected situational information and providing the detected situational information to a situational information managing unit 136 for selecting pre-set reference information corresponding to the situational information, and a first database 138 for storing the pre-set reference information.

A method for controlling the intelligent vehicle information system in accordance with the first embodiment of the present invention will now be explained.

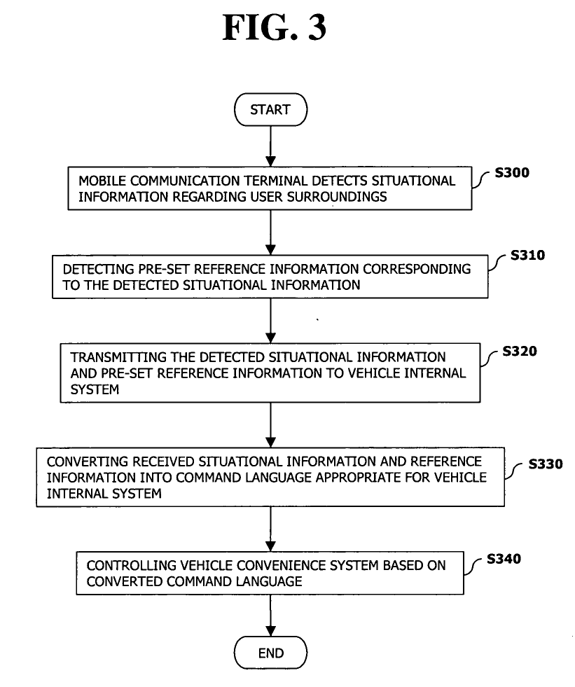

FIG. 3 is a flow chart illustrating a method for controlling the intelligent vehicle information system in accordance with one embodiment of the present invention.

As shown in FIG. 3, the method for controlling the intelligent vehicle information system includes the terminal detecting situational information regarding user surroundings (step S300); the terminal selecting pre-set reference information corresponding to the situational information (step S300), transmitting, the detected situational and pre-set reference information to a vehicle internal system (step S320), the vehicle internal system converting the received situational and pre-set reference information into an appropriate command language (step S330), and providing a control signal used for controlling a vehicle convenience system based on the converted command language (step S340).

The method for controlling the intelligent vehicle information system in accordance with one embodiment of the present invention will now be described in more detail.

First, the terminal 100 checks whether a user is an authenticated user through information provided by the first user recognizing unit 150. Namely, the mobile communication terminal 100 checks whether the user is an authenticated user having authority for controlling the vehicle internal system 200 through a password, fingerprint recognition, voice recognition or an IC security card authentication method. Preferably, the terminal 100 is a mobile phone, a PDA (Personal Digital Assistant, or a notebook personal computer.

When the terminal transmits data indicating that the user is an authenticated user to the vehicle internal system 200 through the first data transmitting/receiving unit 120, the vehicle internal system 200 controls the vehicle convenience system 210 with pre-set values based on the data received through the second data transmitting/receiving unit 240. For example, the vehicle internal system 200 can automatically control the interior cabin temperature, the angle of a power seat, the angle of a rear view mirror, the angle of a side mirror, or the like.

Thereafter, the terminal detects situational information regarding user surroundings through the situational information detecting unit 132 comprising, for example, a temperature sensor for measuring the temperature, a humidity sensor for measuring humidity, or a gyro sensor for measuring an angular velocity, and provides the detected situational information to the situational information recognizing unit 134 (step S300).

Upon receiving the situational information, the situational information recognizing unit 134 provides it to the situational information managing unit 136, and the situational information managing unit 136 selects pre-set reference information corresponding to the received situational information through the first database 138 (step S310).

The situational information managing unit 136 provides the received situational and reference information to the first data transmitting/receiving unit 120, and the first data transmitting/receiving unit 120 transmits the received situational and reference information to the second data transmitting/receiving unit 240 (step S320).

The second data transmitting/receiving unit 240 provides the received situational and reference information to the situational information converter 232, and the situational information converter 232 converts the received situational and reference information into a command language appropriate for the vehicle internal system 200 (step S330).

The vehicle internal controller 230 provides a signal for controlling the vehicle convenience system 210 based on the converted command language according to the real time detected situational information (step S340).

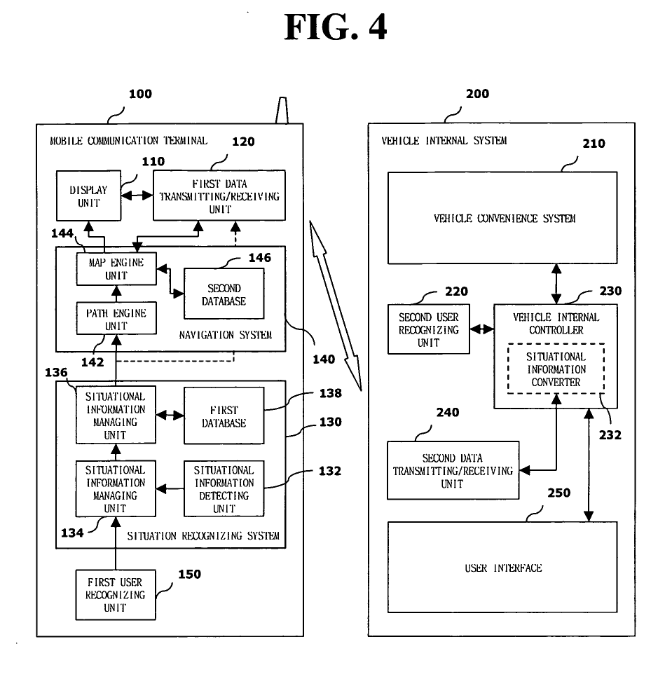

An intelligent vehicle control system in accordance with a another embodiment of the present invention will now be described with reference to FIG. 4.

FIG. 4 is a schematic block diagram of an intelligent vehicle information system in accordance with another embodiment of the present invention.

As shown in FIG. 4, the intelligent vehicle information system includes a navigation system 140 for providing an optimum intelligent road guidance service, wherein the navigation system comprises a path engine unit 142, a map engine unit 144 and a second database 146, and the already-described elements of the intelligent vehicle information system.

The operational principle of the navigation system of the intelligent vehicle control system will be described in detail as follows.

The operational principle for controlling the vehicle internal system 200 in the intelligent vehicle control system is the same as already discussed and therefore, further description will be omitted.

First, the terminal 100 detects situational information through the situational information detecting unit 132, for example, positional information from a GPS receiver for measuring a location of the user, and provides the detected situational information to the situational information recognizing unit 134.

The situational information recognizing unit 134 provides the detected situational information to the path engine unit 142 through the situational information managing unit 136, and the path engine unit 142 determines a path to a desired destination based on the received situational information.

The path engine unit 142 provides the received situational information and the path information to the map engine unit 144, and the map engine unit 144 selects corresponding map data stored in the second database 146 based on the situational and the path information.

Then, the map engine unit 144 provides the selected map data to the display unit 110, for example, an LCD (Liquid Crystal Display) unit, and the display unit 110 displays the selected map data.

The map engine unit 144 can receive traffic information from the first data transmitting/receiving unit 120, whereby it can select an optimum path based on the received traffic information and display the detected optimum path on the display unit 110.

As so far described, the terminal for providing intelligent vehicle information and its method in accordance with the present invention have the following advantages.

That is, for example, the situational information regarding user surroundings and the pre-set reference information are detected through the terminal and then transmitted to the vehicle internal system, whereby the vehicle internal system can be controlled in real time.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A mobile communication terminal for providing intelligent vehicle information, comprising:
a situation recognizing system for detecting real-time situational information and pre-set reference information corresponding to the situational information; and
a data transmission/reception unit for transmitting the detected situational and pre-set reference information to a vehicle internal system.

2. The terminal of claim 1, wherein the situation recognizing system comprises:
a situational information detecting unit for detecting and providing the situational information;
a situational information recognizing unit for receiving the situational information and providing the situational information to a situational information managing unit for detecting the pre-set reference information corresponding to the situational information.

3. The terminal of claim 2, wherein the situation recognizing system further comprises:
a database for storing the pre-set reference information corresponding to the situational information.

4. The terminal of claim 2, wherein the situational information detecting unit comprises at least one of a temperature sensor, a humidity sensor, a gyro sensor for measuring an angular velocity, and a GPS receiver for measuring a location of a user.

5. The terminal of claim 1, further comprising:
a user recognizing unit for receiving information from a user to determine whether the user is an authorized user.

6. The terminal of claim 5, wherein the user recognizing unit determines whether the user is an authorized user using at least one of a password, fingerprint recognition, voice recognition and an IC (Integrated Circuit) card identification methods.

7. The terminal of claim 1, further comprising:
a navigation system for providing an optimum route selection responsive to the situational information.

8. The terminal of claim 7, wherein the navigation system comprises:
a path engine unit for determining an optimum route to a destination provided by the user and responsive to the detected situational information; and
a map engine unit for providing map data responsive to the optimum route.

9. The terminal of claim 8, wherein the navigation system further comprises:
a database for storing the map data.

10. A method for providing intelligent vehicle information comprising:
detecting real-time situational information inside a vehicle and pre-set reference information corresponding to the situational information; and
transmitting the detected situational and pre-set reference information to a vehicle internal system.

11. The method of claim 10, further comprising:
receiving information from a user and determining whether the user is an authorized user based on the provided information.

12. The method of claim 11, wherein, determining the authorized user further comprises identifying the authorized user using at least a password, fingerprint recognition, voice recognition and an IC (Integrated Circuit) card Identification methods.

13. The method of claim 10, wherein the situational information comprises at least one of temperature, humidity, angular velocity and a location of the user.

14. The method of claim 10, further comprising:
providing an optimum route selection responsive to the detected situational information.

15. A vehicle information control system comprising:
a mobile communication terminal for detecting situational information regarding user surroundings and pre-set reference information corresponding to the detected situational information, and transmitting the detected situational and pre-set reference information; and
a vehicle internal system for receiving the transmitted situational and pre-set reference information and being controlled in real time based on the received situational and pre-set reference information.

16. The system of claim 15, wherein the mobile communication terminal comprises:
a situation recognizing system for detecting the situational information and the pre-set reference information corresponding to situational information; and
a data transmitting/receiving unit for transmitting the detected situational and pre-set reference information.

17. The system of claim 16, wherein the situation recognizing system comprises:
a situational information detecting unit for detecting and providing the situational information;
a situational information recognizing unit for receiving the situational information and providing the situational information to a situational information managing unit for selecting pre-set reference information corresponding to the managing unit situational information.

18. The system of claim 16, wherein the mobile communication terminal further comprises:
a navigation system for providing an optimum route selection responsive to the situational information.

19. The system of claim 18, wherein the navigation system comprises:
a path engine unit for determining an optimum route to a destination provided by the user and responsive to the detected situational information; and
a map engine unit for providing map data responsive to the optimum route.

20. The system of claim 15, wherein the vehicle internal system comprises:
a data transmitting/receiving unit for receiving the transmitted situational and pre-set reference information;
a situational information converting unit for converting the received situational and pre-set reference information into an appropriate command language; and
a vehicle internal controller for providing a control signal for controlling a vehicle convenience system using the converted command language.

21. A method for controlling an intelligent vehicle information system comprising:
detecting real-time situational information regarding the interior of a vehicle and pre-set reference information corresponding to the detected situational information using a mobile communication terminal;
transmitting the situational and pre-set reference information to a vehicle internal system using the mobile communication terminal; and
providing by the vehicle internal system, a control signal based on the received situational and pre-set reference information.

22. The method of claim 21, further comprising:
receiving information from a user and determining whether the user is an authorized user.

23. The method of claim 21, further comprising:
providing an optimum route selection based on the detected situational information.

24. The method of claim 22, wherein providing the control signal further comprises:
converting the received situational information and pre-set reference information into an appropriate command language; and
providing the control signal based on the command language.
